(19) United States
(12) Patent Application Publication
(10) Pub. No.: US 2010/0313697 A1
(43) Pub. Date: Dec. 16, 2010

(54) BREAK AND EXCELATOR UNITY DEVICE

(76) Inventor: Ji Hyun Ma, Jeonbook (KR)

Correspondence Address: Jae Y. Park, Kile, Park, Goekjian, Reed & McManus, PLLC, 1200 New Hampshire Ave. NW, Suite 570, Washington, DC, 20036, US

(21) Appl. No.: 12/446,160

(22) PCT Filed: Oct. 23, 2007
(86) PCT No.: PCT/KR07/05188

§ 371 Date: Apr. 17, 2009

(30) Foreign Application Priority Data
Oct. 24, 2006 (KR) 10-2006-0103573

(51) Int. Cl. G05G 1/30

(52) U.S. Cl. 74/512

(57) ABSTRACT

The present invention relates to a brake and accelerator unity device, and more particularly, to a brake and accelerator unity device in that a brake pedal and an accelerator pedal of a car are combined into one pedal, so that the function of the brake and accelerator can be conducted at the same time. According to the brake and accelerator unity device, the brake pedal and the accelerator pedal of the car are combined into one pedal, so that the function of the brake and accelerator can be conducted at the same time, whereby it can prevent the accelerator pedal from being hit in emergencies, the driver fatigue such as an ankle spasm and so forth generated by frequent movement between the brake pedal and accelerator pedal can be decreased during traffic jams or long-distance operation, and a jackrabbit start accident can be prevented through the combination of the brake and accelerator.

### TECHNICAL FIELD

The present invention relates to a brake and accelerator unity device, and more particularly, to a brake and accelerator unity device in that a brake pedal and an accelerator pedal of a car are combined into one pedal, so that the function of the brake and accelerator can be conducted at the same time.

### BACKGROUND ART

Generally, a brake pedal and an accelerator pedal are separated from each other in a car. Accordingly, the driver should quickly and accurately operate the brake pedal and accelerator pedal separately from the existing state of things.

However, since the driver must operate the brake pedal and accelerator pedal separately during operation thereof, it is very difficult for the driver to quickly and accurately operate the car from the existing state of things. That is, in emergencies, the driver should hit the brake. However, he wrongly hits the accelerator pedal in emergencies, thereby it can bring about a serious traffic accident.

Also, during traffic jams or long-distance operation, the driver fatigue such as an ankle spasm and so forth can be increased owing to a frequent movement between the brake pedal and accelerator pedal.

### DISCLOSURE

### Technical Problem

Accordingly, the present invention has been made to solve the above-mentioned problems occurring in the prior art, and an object of the present invention is to provide to a brake and accelerator unity device in that a brake pedal and an accelerator pedal of a car are combined into one pedal, so that the function of the brake and accelerator can be conducted at the same time.

### Technical Solution

To achieve the above objects of the present invention, there is provided a brake and accelerator unity device for a car comprising: a brake axis; a brake pedal extending and connected to the brake axis; an accelerator pedal for increasing and decreasing speed according to right and left movement thereof located at an upper portion of the brake pedal; a sliding means for moving the accelerator pedal right and left located between the brake pedal and the accelerator pedal; an electric contact sensor for sensing an operation condition of the brake pedal and transmitting the sensed signals to an electronic control unit; the electronic control unit for controlling a solenoid valve according to the operation of the brake pedal and the accelerator pedal; and the solenoid valve for restoring the operating accelerator pedal according to the operating signal of the electronic control unit during the operation of the brake pedal. Preferably, the sliding means comprises guide grooves for guiding the accelerator pedal right and left located between the brake pedal and the accelerator pedal and ball bearings for smoothly moving the accelerator pedal right and left inserted into the guide grooves.

### ADVANTAGEOUS EFFECTS

As described above, according to the brake and accelerator unity device, the brake pedal and the accelerator pedal of the car are combined into one pedal, so that the function of the brake and accelerator can be conducted at the same time, whereby it can prevent the accelerator pedal from being wrongly hit in emergencies, the driver fatigue such as an ankle spasm and so forth generated by frequent movement between the brake pedal and accelerator pedal can be decreased during traffic jams or long-distance operation, and a jackrabbit start accident can be prevented through the combination of the brake and accelerator.

### DESCRIPTION OF DRAWINGS

The above as well as the other objects, features and advantages of the present invention will be more apparent from the following detailed description taken in conjunction with the accompanying drawings, in which:

FIG. 1 is a perspective view illustrating a brake and accelerator unity device according to the present invention;

FIG. 2 is a sectional view illustrating a brake and accelerator unity device according to the present invention; and

FIG. 3 is a block diagram illustrating a brake and accelerator unity device according to the present invention.

### BEST MODE

A preferred embodiment of the invention will be described in detail below with reference to the accompanying drawings.

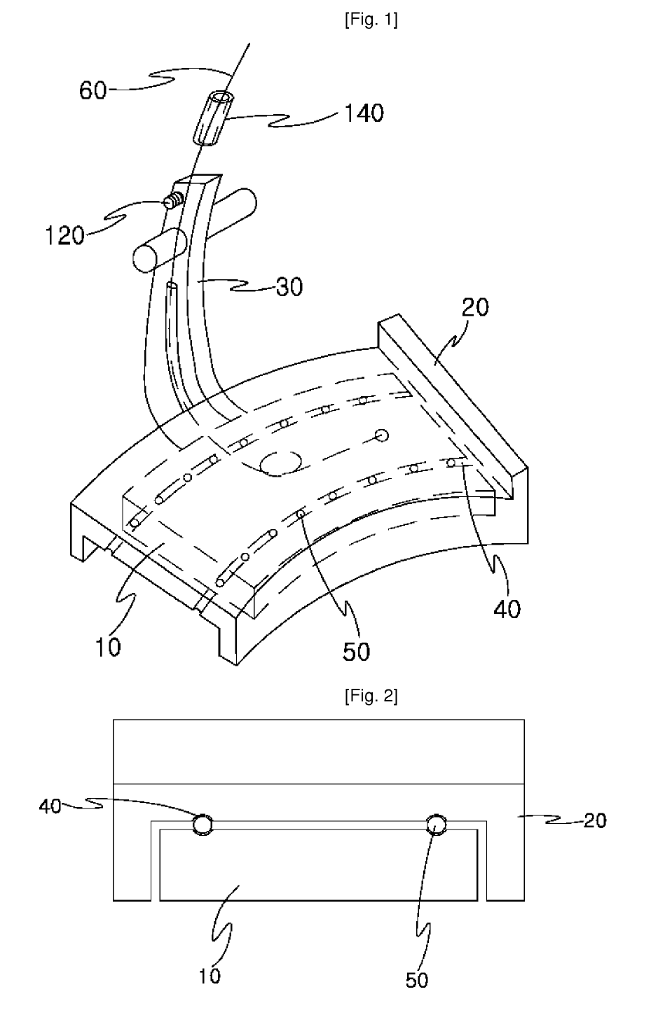

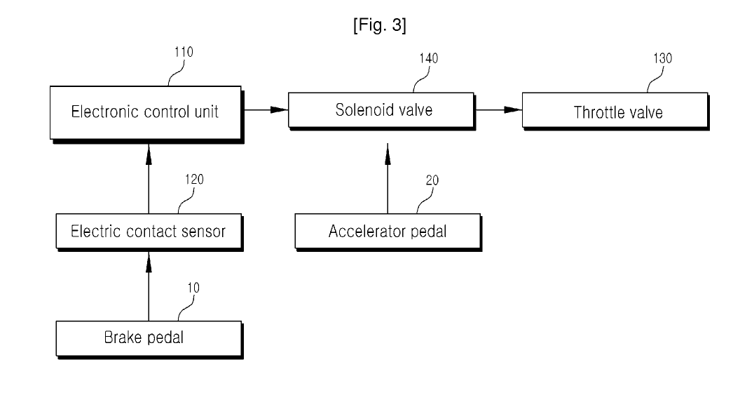

FIG. 1 is a perspective view illustrating a brake and accelerator unity device according to the present invention, FIG. 2 is a sectional view illustrating a brake and accelerator unity device according to the present invention, and FIG. 3 is a block diagram illustrating a brake and accelerator unity device according to the present invention. As shown in FIG. 1 through FIG. 3, the brake and accelerator unity device for a car includes a brake axis 30, a brake pedal 10 extending and connected to the brake axis 30, an accelerator pedal 20 for increasing and decreasing speed according to right and left movement thereof located at an upper portion of the brake pedal 10, a sliding means for moving the accelerator pedal 20 right and left located between the brake pedal 10 and the accelerator pedal 20, an electric contact sensor 120 for sensing an operation condition of the brake pedal 10 and transmitting the sensed signals to an electronic control unit 110, the electronic control unit 110 for controlling a solenoid valve 140 according to the operation of the brake pedal 10 and the accelerator pedal 20, and the solenoid valve 140 for restoring the operating accelerator pedal 20 according to the operating signal of the electronic control unit 110 during the operation of the brake pedal 20.

Here, the sliding means includes guide grooves 40 for guiding the accelerator pedal 20 right and left located between the brake pedal 10 and the accelerator pedal 20 and ball bearings 50 for smoothly moving the accelerator pedal 20 right and left inserted into the guide grooves 40.

As shown in FIG. 1, in the brake and accelerator unity device for the car, the accelerator pedal 20 is formed at the upper portion of the brake pedal 10 extending and connected to the brake axis 30. Here, the accelerator pedal 20 is moved right and left, so that the speed of the car can be increased and decreased. Accordingly, it is necessary to form the sliding means between the brake pedal 10 and the accelerator pedal 20 so as to smoothly move the accelerator pedal 20 right and left.

As shown in FIG. 2, the sliding means includes guide grooves 40 for guiding the accelerator pedal 20 right and left located between the brake pedal 10 and the accelerator pedal 20 and ball bearings 50 for smoothly moving the accelerator pedal 20 right and left inserted into the guide grooves 40.

Preferably, a projecting portion is formed at one end portion of the accelerator pedal 20, so that it can prevent the driver's foot from being located at the outside of the accelerator pedal 20 during restoring of the operating accelerator pedal 20.

FIG. 3 is a block diagram illustrating a brake and accelerator unity device according to the present invention.

The operation of the brake and accelerator unity device according to the present invention will be described below with reference to FIG. 3. Firstly, where the driver hits the brake and accelerator unity device during driving of the car, the electric contact sensor 120 senses the operation condition thereof and transmits the sensed signals to the electronic control unit 110, so that the solenoid valve 140 allows the operating accelerator pedal 20 to be restored as the removed distance thereof according to the operating signal of the electronic control unit 110.

In the meantime, after braking of the car, the brake pedal 10 and the accelerator pedal 20 return to normal and the power supply of the solenoid valve 140 is cut through the electric contact sensor 120, so that the speed of the car can be increased and decreased speed according to right and left movement of the accelerator pedal 20. Here, the electronic control unit 110 can control an engine, an automatic transmitter, and an ABS and so forth through a computer system. Since the technical construction and operation theory are well known in the art, further description on this is omitted here. In other words, the accelerator pedal 20 is moved right and left, so that a throttle valve 130 is opened and closed, thereby the speed of the car can be increased and decreased. Also, where the driver hits the brake pedal under any circumstances, the electronic control unit 110 sends the operating signals to the solenoid valve 140, thereby restoring the accelerator pedal 20.

Here, the solenoid valve 140 is connected to the throttle valve 130 through a wire 60, so that the throttle valve serves to increase and decrease the speed of the car by means of the wire 60.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

The present invention relates to a brake and accelerator unity device in that a brake pedal and an accelerator pedal of a car are combined into one pedal, so that the function of the brake and accelerator can be conducted at the same time.

1. A brake and accelerator unity device for a car comprising:
a brake axis;
a brake pedal extending and connected to the brake axis;
an accelerator pedal for increasing and decreasing speed according to right and left movement thereof located at an upper portion of the brake pedal;
a sliding means for moving the accelerator pedal right and left located between the brake pedal and the accelerator pedal;
an electric contact sensor for sensing an operation condition of the brake pedal and transmitting the sensed signals to an electronic control unit;
the electronic control unit for controlling a solenoid valve according to the operation of the brake pedal and the accelerator pedal; and
the solenoid valve for restoring the operating accelerator pedal according to the operating signal of the electronic control unit during the operation of the brake pedal.

2. A brake and accelerator unity device for a car as claimed in claim 1, wherein the sliding means comprises guide grooves for guiding the accelerator pedal right and left located between the brake pedal and the accelerator pedal and ball bearings for smoothly moving the accelerator pedal right and left inserted into the guide grooves.
